(19) United States
(12) Patent Application Publication
(10) Pub. No.: US 2026/0153720 A1
(43) Pub. Date: Jun. 4, 2026

(54) PTYCHOGRAPHIC IMAGING METHOD AND IMAGING SYSTEM

(71) Applicant: GSI Helmholtzzentrum für Schwerionenforschung GmbH, Darmstadt (DE)

(72) Inventors: Jan ROTHHARDT, Jena (DE); Wilhelm ESCHEN, Jena (DE)

(73) Assignee: GSI Helmholtzzentrum für Schwerionenforschung GmbH, Darmstadt (DE)

(21) Appl. No.: 19/408,444

(22) Filed: Dec. 4, 2025

(30) Foreign Application Priority Data
Dec. 4, 2024 (DE) 10 2024 136 129.8
Nov. 21, 2025 (DE) 10 2025 148 488.0

(51) Int. Cl. G02B 21/36; G02B 21/06

(52) U.S. Cl. CPC G02B 21/367; G02B 21/06

(57) ABSTRACT

The disclosure relates to an imaging method and an imaging system for carrying out this method. The disclosure provides an improved multispectral ptychographic imaging method and a corresponding system. For this, the imaging method of the disclosure comprises the following steps: Generation of at least partially coherent electromagnetic radiation (3) which contains spectral components at at least two different wavelengths; spatial separation of the spectral components of the electromagnetic radiation, for example by angular dispersion; generation of structured illumination beams (9) by selecting respectively one of the spectral components by means of a structured aperture (8a, 8b, 8c); moving an object (6) in a direction transverse to the path of the illumination beams (9) into a plurality of positions; detecting an intensity pattern for each of the positions, wherein the intensity patterns are generated by scattering and/or diffraction of the illumination beams (9) at the object (6) in a detection plane; and reconstructing an image of the object (6) from the detected intensity patterns, wherein for each of the at least two wavelengths an image of the object (6) is calculated by means of a ptychographic reconstruction algorithm.

### RELATED APPLICATIONS

This application claims the benefit of priority of German Patent Application No. 10 2024 136 129.8 filed on Dec. 4, 2024 and German Patent Application No. 10 2025 148 488.0 filed on Nov. 21, 2025 the contents of which are all incorporated by reference as if fully set forth herein in their entirety.

### TECHNICAL FIELD

The disclosure relates to a ptychographic imaging method and an imaging system for carrying out the method.

### BACKGROUND

The ptychography is a computer-based imaging method in which images are generated by processing two or more intensity patterns created by diffraction or scattering of at least partially coherent light on an object through interference. The intensity patterns are generated by a constant illumination function (for example, focus geometry of the illumination radiation or geometry of an aperture/diaphragm) that moves laterally relative to the object, that is, with a component transverse to the beam path of the light, by a known amount sideways. The intensity patterns occur at some distance from the object, so that the diffracted or scattered light waves of the illumination radiation spread, superimpose, and interfere with each other to produce the intensity patterns.

Ptychography can be performed with any at least partially coherent radiation, among others visible light, X-rays, extreme ultraviolet (XUV), or even electron radiation. In contrary to conventional lens imaging, ptychography is not affected by lens-induced aberrations. The intensity patterns are usually generated without lenses. This is important for imaging at very short wavelengths (<100 nm), where it is difficult and expensive to manufacture high-quality lenses with high numerical apertures.

Another advantage of ptychography is that it can image transparent objects. This is because the method responds to the phase of the illumination radiation that has passed through the object. In the case of biological microscopy with visible light, this means that cells do not need to be stained or labeled to create contrast.

Although the illumination radiation diffracted or scattered by the object is detected as an intensity pattern in ptychography, the mathematical constraint imposed by the translational invariance of the illumination, combined with the known lateral shifts between them, means that the phase of the wave field can be reconstructed by a computer using an inverse calculation (ptychographic reconstruction algorithm). This allows all information about the wave field of the diffracted or scattered illumination radiation (amplitude and phase) to be recovered, and nearly perfect and quantitative images of the object to be obtained, with a spatial resolution that is significantly smaller than the size of the illuminated area on the object. The requirements for the illumination optics are comparatively low (J. Rodenburg and A. Maiden, “Ptychography” in “Springer Handbook of Microscopy”, edited by P. W. Hawkes and J. C. H. Spence, Springer International Publishing, 2019, pages 819 to 904).

In the recent years, laser-driven coherent radiation sources in the extreme ultraviolet (XUV) range have undergone enormous performance improvements, enabling high-resolution ptychography on a laboratory scale. The latest implementations achieve resolutions down to the sub-20 nm range and allow imaging with quantitative amplitude and phase contrast, including spatially resolved material identification based on the measured complex refractive index.

The illumination light sources typically used for ptychography are inherently broadband. However, only a small portion of the broad spectrum is usually used due to spectral filtering. This has the disadvantage that a large part of the light output is lost unused.

Multispectral imaging can be used to obtain spectroscopic information about the object under investigation, which is useful for many applications (D. A. Shapiro et al., “Chemical composition mapping with nanometer resolution by soft X-ray microscopy”, Nat. Photonics, vol. 8, no. 10, pp. 765-769).

In recent years, ptychographic reconstruction algorithms have been developed that also work with spectrally broadband illumination radiation. This allows spectroscopic information to be obtained from the object under investigation (D. J. Batey, D. Claus, and J. M. Rodenburg, “Information multiplexing in ptychography”, Ultramicroscopy, Volume 138, Pages 13-21). This methodology is also known as multiwavelength ptychography (MWP). MWP algorithms can be used to reconstruct the phase delay and transmission in the object as a function of wavelength. The intensity patterns generated and detected by superimposing the various spectral components of the illumination radiation are evaluated in such a way that the contributions of the various spectral components are separated. However, this method has the disadvantage that the MWP reconstruction algorithm is susceptible to noise and other measurement inaccuracies. The reason for this is that broadband illumination radiation leads to intensity patterns that can be described by a superposition of many monochromatic, coherent diffraction images. Using MWP, the different monochromatic components that result in the measured intensity pattern must be reconstructed. Thus, image generation in MWP involves a complex inverse problem that is significantly more difficult and time-consuming to solve than in monochromatic ptychography.

### SUMMARY

The disclosure provides an imaging method with:
Generation of at least partially coherent electromagnetic radiation which contains spectral components at at least two different wavelengths,
spatial separation of the spectral components of the electromagnetic radiation,
generation of structured illumination beams by selecting respectively one of the spectral components using a structured aperture,
moving an object in a direction transverse to the path of the illumination beams into a plurality of positions.

In addition, the disclosure provides an imaging system with
an illumination light source arranged for generation of at least partially coherent electromagnetic radiation which contains spectral components at at least two different wavelengths,
a separating element, arranged for spatial separation of the spectral components of the electromagnetic radiation,
a mask with at least one structured aperture, arranged for generation of structured illumination beams by selecting respectively one of the spectral components by means of the structured aperture,
a positioning element, arranged for moving the object in a direction transverse to the path of the illumination beams.

### BRIEF DESCRIPTION OF THE DRAWINGS

Examples of embodiments of the disclosure are explained in more detail below with reference to the drawings.

FIG. 1 shows a schematic representation of an imaging system according to the disclosure in a first embodiment (transmission setup);

FIG. 2 shows a schematic representation of an imaging system according to the disclosure in a second embodiment (reflection setup);

FIG. 3 shows a schematic representation of masks with structured apertures for use according to the disclosure.

### DETAILED DESCRIPTION

The disclosure provides an imaging method with the following steps:
Generation of at least partially coherent electromagnetic radiation which contains spectral components at at least two different wavelengths,
spatial separation of the spectral components of the electromagnetic radiation,
generation of structured illumination beams by selecting respectively one of the spectral components using a structured aperture,
moving an object in a direction transverse to the path of the illumination beams into a plurality of positions,
detecting an intensity pattern for each of the positions, wherein the intensity patterns are generated by scattering and/or diffraction of the illumination beams at the object in a detection plane, and
reconstructing an image of the object from the detected intensity patterns, wherein for each of the at least two wavelengths an image of the object is calculated by means of a ptychographic reconstruction algorithm.
In addition, the disclosure provides an imaging system with
an illumination light source arranged for generation of at least partially coherent electromagnetic radiation which contains spectral components at at least two different wavelengths,
a separating element, arranged for spatial separation of the spectral components of the electromagnetic radiation,
a mask with at least one structured aperture, arranged for generation of structured illumination beams by selecting respectively one of the spectral components by means of the structured aperture,
a positioning element, arranged for moving the object in a direction transverse to the path of the illumination beams,
an area detector, arranged for detecting intensity patterns which are generated by scattering or diffraction of the illumination radiation at the object in a detection plane defined by the plane of the area detector,
a control unit, arranged for controlling the positioning element and the area detector in such a way that the object is moved sequentially into two or more predetermined positions and several intensity patterns are detected, wherein each of the positions is assigned to a detected intensity pattern, and
a computer which is configured by software to reconstruct an image of the object from the detected intensity patterns for each of the at least two wavelengths by means of a ptychographic reconstruction algorithm.

The disclosure further develops the conventional imaging technique of ptychography. Illumination radiation is generated to illuminate the object to be examined, and the object is successively moved to a plurality of positions with a directional component transverse to the path of the illumination rays. The intensity patterns generated by scattering and/or refraction at the object in a detection plane are detected for each of the positions. Finally, an image of the object is calculated from the detected intensity patterns using a ptychographic reconstruction algorithm.

According to the disclosure, the spectral components of the spectrally broadband electromagnetic radiation used to illuminate the object are spatially separated. This can be achieved, for example, by angular dispersion (using a diffraction grating or a prism) so that the different spectral components have different directions of propagation. Other types of splitting of the electromagnetic radiation into spatially separated components, each of which is assigned specific wavelengths or wavelength ranges, are also conceivable, such as by beam splitters in combination with spectrally selective filters.

In one possible embodiment of the imaging system according to the disclosure, the separating element is therefore expediently an angularly dispersive optical element, for example a diffraction grating or a prism, arranged in the beam path between the illumination light source and the mask.

The disclosure is based on combining the spatial separation of spectral components with the generation of structured illumination beams by selecting respectively one of the spectral components by means of a structured aperture. Due to the spatial separation, each of the illumination beams is assigned a spectral component of the originally generated electromagnetic radiation, and due to the structured aperture used for selection, each of the illumination beams is structured accordingly. The use of structured illumination beams improves image quality compared to unstructured beams (for example, Gaussian beams) (M. Guizar-Sicairos, M. Holler, A. Diaz, J. Vila-Comamala, O. Bunk, and A. Menzel, “Role of the illumination spatial-frequency spectrum for ptychography”, Phys. Rev. B, vol. 86, no. 10, p. 100103; M. Odstrc̆il, M. Lebugle, M. Guizar-Sicairos, C. David, and M. Holler, “Towards optimized illumination for high-resolution ptychography”, Opt. Express, vol. 27, no. 10, p. 14981). This is mainly because structuring the beam increases the angular spectrum. Since the measured diffraction pattern can be described as a convolution of the object angular spectrum with the illumination angular spectrum, a structured beam results in a larger convolution kernel. The larger angular spectrum allows a higher diffraction-limited resolution to be achieved; the intensity pattern is distributed more evenly across the area detector, reducing the requirements for the dynamic range of the area detector; in addition, the structured illumination beams lead to better convergence of the ptychographic reconstruction algorithm used.

The disclosure defines a structured aperture as any optical component that modifies the intensity distribution, phase distribution, or polarization distribution of the illumination beam across the beam cross-section for the purpose of targeted beam shaping. For this, the structured aperture has at least one of the following spatially varying properties:
Transmission and absorption: The electromagnetic radiation light is only transmitted through certain areas of the aperture, while certain other areas of the aperture block or attenuate the light, creating shadow patterns or intensity profiles (as with a diaphragm).
Phase modulation: The electromagnetic radiation undergoes spatially different phase shifts through the structured aperture, which lead to corresponding modifications of the wavefront.
Polarization: the polarization direction of the light is specifically changed in different areas of the aperture.

With regard to MWP, one embodiment of the disclosure is that, after spatial separation of the different spectral components by means of various structured apertures, accordingly differently structured illumination beams can be generated, that is, the illumination beams have different amplitude profiles, phase profiles and/or polarization profiles at different wavelengths or in different wavelength ranges, making the reconstruction problem easier and more straightforward to solve. Intuitively, this can be explained by the fact that the wavelength-dependent different structuring of the illumination beams results in a coding of the spectral components, which makes it easier for the ptychographic reconstruction algorithm to separate the contributions of the different spectral components to the detected intensity patterns. In other words, one of the insights of the disclosure is that the inverse problem underlying image reconstruction can be significantly better conditioned by the wavelength-dependent structuring of the illumination beams according to the disclosure.

The approach of the disclosure can in principle be implemented in two different ways:
In one possible embodiment, the illumination beams can be generated by selecting different spectral components in succession over time by means of the structured aperture and detecting accordingly in succession over time intensity patterns for the wavelengths respectively assigned to the spectral components, wherein an image of the object is reconstructed for each wavelength from the intensity patterns assigned to that wavelength. In this variant, a single aperture can be used to select a spectral component and spatially structure the illumination beam. By adjusting, for example, an angle-dispersive optical element used for the spatial separation of the spectral components or the aperture, ptychography measurements can be performed for many different wavelengths monochromatically in succession over time (serially). This allows spatially resolved spectroscopic information about the object to be obtained. In this case, it is not necessary to use an MWP algorithm; a normal, monochromatic ptychographic reconstruction algorithm is sufficient.

In another possible design, multiple illumination beams are generated simultaneously by selecting spectral components in parallel by means of multiple structured apertures. The apertures assigned to the different spectral components can for example be structured differently in order to encode the different spectral components differently, as described above. The intensity patterns are detected while the object is simultaneously illuminated with the multiple illumination beams. This variant of the disclosure requires multiple apertures. In this case, an MWP algorithm is used for reconstruction. This makes it possible to measure the object transmission function for multiple wavelengths simultaneously (in parallel) with only one ptychography measurement.

For implementation of this variant, the mask arranged expediently transverse to the beam path between the separating element and the object in the imaging system used may have several structured apertures arranged next to and/or above each other. In this case, a specific spectral component is selected according to the positioning of the aperture on the mask. Several apertures can be arranged as an array. The apertures on the mask can be structured differently so that the illumination beams assigned to the different wavelengths are structured differently. In combination with the positioning of the apertures, the various spectral components selected in parallel can thus be coded differently by the structuring, as described above.

For example, the intensity patterns can be detected without imaging optics, as is customary in ptychography. Imaging errors of optical components therefore play no role in imaging. Insofar as optical components are used to illuminate the object, that is, to direct the illumination beams onto an area of the object, these should be as achromatic as possible with regard to the different illumination wavelengths. In the imaging system of the disclosure, for example, a focusing optic may be arranged in the beam path between the separating element and the mask, which is intended to focus the illumination beams on the object.

In an embodiment, areas of the object illuminated by the illumination beams in adjacent positions should overlap spatially. The overlap is for example for conditioning the image reconstruction based on the intensity patterns.

The imaging method according to the disclosure is suitable for illumination wavelengths in the range between 0.01 nm and 3 mm, for example in the X-ray range, in the XUV range, in the VIS range, in the IR range, in the midIR range, or in the THz range. This covers the relevant practical fields of application of the disclosure.

In one possible embodiment, the imaging system according to the disclosure can be designed so that the separating element and the mask can be variably aligned and/or positioned relative to each other in order to vary the spectral components selected by the mask. For example, for this the angularly dispersive optical element can be rotatable about an axis oriented perpendicular to the plane of the beam path.

### DETAILED DESCRIPTION OF THE DRAWINGS

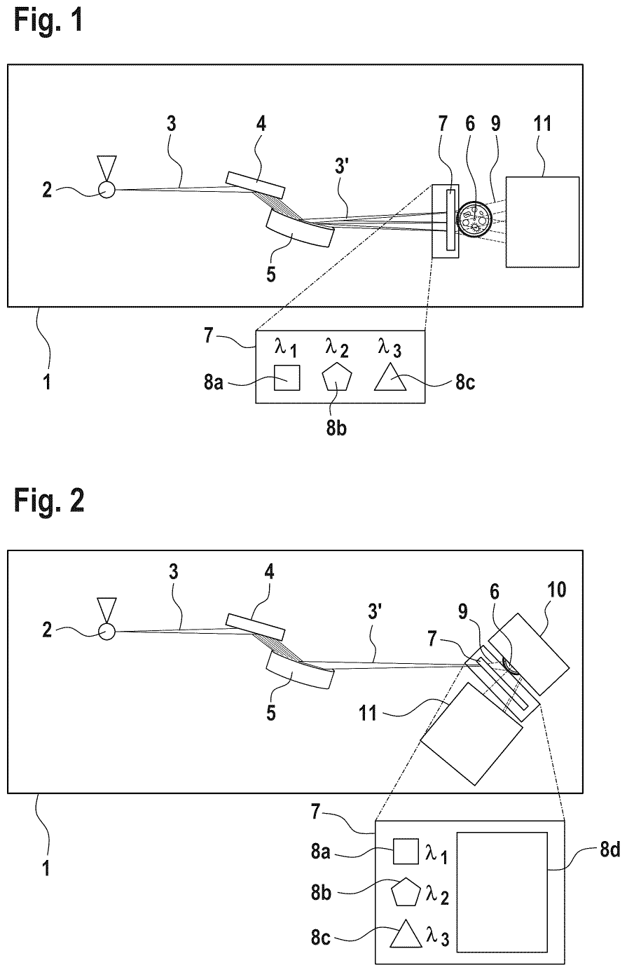

FIGS. 1 and 2 each show schematically an imaging system 1 for the multispectral ptychography. The system 1 comprises a broadband illumination light source 2 that emits coherent electromagnetic radiation 3 with spectral components at at least two different wavelengths. An angularly dispersive optical element 4, for example a diffraction grating, is located in the beam path of the electromagnetic radiation 3 which acts as a separating element for the spatial separation of the spectral components of the electromagnetic radiation 3. The angularly dispersive optical element 4 gives the individual spectral components different emission directions. The angularly dispersive optical element 4 is followed in the beam path by a focusing optic 5, for example a toroidal mirror, which focuses the electromagnetic radiation 3′ after the spectral selective spatial separation. Between the focusing optics 5 and the object 6 there is a mask 7 in the beam path—in the focus of the optics 5—with several structured apertures 8a, 8b, 8c (respectively enlarged represented in the FIGS. 1 and 2 below). The different structures of the apertures 8a, 8b, 8c are illustrated schematically by different geometric shapes. The mask 7 with the structured apertures 8a, 8b, 8c generates structured illumination beams 9 according to their respective spatial arrangement in the beam path by selecting respectively one of the spectral components. A positioning element 10 (shown only in FIG. 2), for example an XY piezo positioning table, is arranged for two-dimensional movement of the object 6 with directional components transverse to the path of the illumination beams 9. Finally, the imaging system 1 comprises an area detector 11, for example a CCD element, which serves for detection of intensity patterns generated by scattering or diffraction of the illumination beams 9 on the object 6 in a detection plane defined by the plane of the area detector 11. A control unit (not shown) controls the positioning element 10 and the area detector 11 so that the object 6 is moved sequentially to two or more predetermined positions and multiple intensity patterns are detected by means of the area detector 11, wherein each of the positions is assigned a detected intensity pattern. Finally, a computer (not shown) reconstructs an image of the object 6 for each of the at least two wavelengths from the detected intensity patterns by means of a ptychographic reconstruction algorithm (MWP algorithm).

The imaging system 1 of FIG. 2 differs from that of FIG. 1 in that, in FIG. 2, the area detector 11 detects the light reflected from the object 6, whereas the area detector 11 in FIG. 1 measures the light transmitted through the object 6. Since the light in FIG. 2 is reflected in the direction of the mask 7, the mask has a large rectangular aperture 8d through which the reflected light can pass and then be detected by the area detector 11.

The disclosure is based on the fact that the angularly dispersive optical element 4, in conjunction with the focusing optics 5, spatially separates the spectral components of the electromagnetic radiation from the illumination light source 2 on the mask 7, which is located directly in front of the object 6. On the mask 7 are structured (e.g., nanostructured) apertures 8a, 8b, 8c, which are used to select the desired wavelength in each case. The angularly dispersive optical element 4, the focusing optics 5, and the mask 7 can all be moved by positioners (not shown). This allows different wavelengths to be selected or a wavelength range to be sampled (scanned). Mask 7 can be a simple amplitude mask, phase mask, or a combined element. The mask 7 is placed directly in front of the object 6 so that the near-field transmission of the apertures 8a, 8b, 8c leads to exposure on the object. The image generation works without lenses using ptychography, as described above. A corresponding image is reconstructed for each wavelength used.

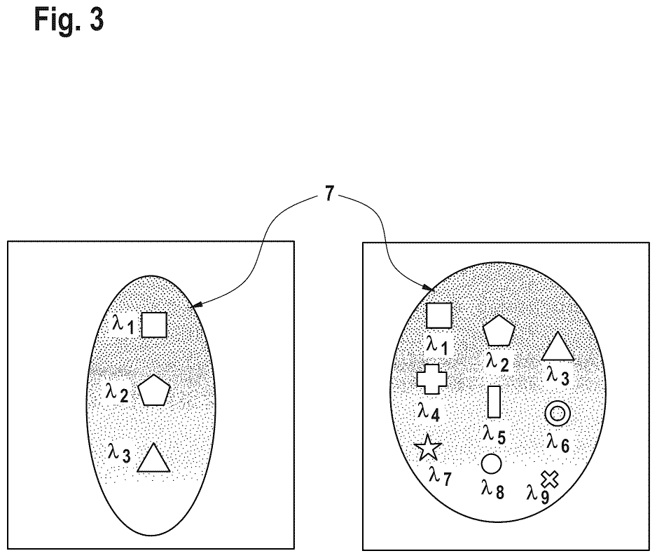

The FIG. 3 schematically shows two examples of masks 7 that can be used in the imaging systems 1 (FIGS. 1, 2) described above. In the examples shown, the dispersive separation of the spectral wavelengths works in such a way that the wavelength varies in the vertical direction, that is, from top to bottom across the mask 7. In the left example, three differently structured apertures are arranged one above the other, which are assigned to the different wavelengths λ₁, λ₂, λ₃ according to their vertical position. The illumination beams generated at the three wavelengths are structured differently accordingly. According to the approach of the disclosure, this results in improved multispectral image reconstruction. In the right-hand example in FIG. 3, the mask 7 has an array of a total of nine structured apertures. The different structures are schematically illustrated by different geometric shapes. As can be seen, the apertures arranged in a row next to each other are slightly offset from each other in the vertical direction, that is, in the direction of the spatial separation of the spectral components. This makes it possible to generate differently structured illumination beams at a total of nine different wavelengths λ₁ to λ₉, with a spectral resolution that is greater than would actually result from the sizes of the individual apertures.

One aspect of the disclosure over the prior art is that many microscopic images for different wavelengths can be quickly measured and reconstructed. The spatially separated structuring of the illumination beams at different wavelengths simplifies reconstruction and thus significantly improves the image quality achieved. Simultaneous (parallel) measurement at multiple wavelengths offers a decisive speed for example over conventional methods.

The disclosure provides an improved multispectral ptychographic imaging method and a corresponding system.

1. Imaging method with the following method steps:
Generation of at least partially coherent electromagnetic radiation (3) which contains spectral components at at least two different wavelengths,
spatial separation of the spectral components of the electromagnetic radiation,
generation of structured illumination beams (9) by selecting respectively one of the spectral components by means of a structured aperture (8a, 8b, 8c),
moving an object (6) in a direction transverse to the path of the illumination beams (9) into a plurality of positions,
detecting an intensity pattern for each of the positions, wherein the intensity patterns are generated by scattering and/or diffraction of the illumination beams (9) at the object (6) in a detection plane, and
reconstructing an image of the object (6) from the detected intensity patterns, wherein for each of the at least two wavelengths an image of the object (6) is calculated by means of a ptychographic reconstruction algorithm.

2. Method according to claim 1, wherein the spatial separation of the spectral components is achieved by angular dispersion.

3. Method according to claim 1, wherein the illumination beams (9) are generated by selecting different spectral components in succession over time by means of the structured aperture (8a, 8b, 8c) and accordingly intensity patterns for the wavelengths assigned to the spectral components are detected in succession over time, wherein an image of the object (6) is reconstructed for each wavelength from the intensity patterns assigned to that wavelength.

4. Method according to claim 1, wherein a plurality of illumination beams (9) are generated simultaneously by selecting spectral components by means of a plurality of structured apertures (8a, 8b, 8c).

5. Method according to claim 3, wherein the apertures (8a, 8b, 8c) associated with the different spectral components are structured differently.

6. Method according to claim 4, wherein the intensity patterns are detected while the object (6) is illuminated simultaneously with the plurality of illumination beams (9).

7. Method according to claim 1, wherein the intensity patterns are detected without imaging optics.

8. Method according to claim 1, wherein the different wavelengths are in the range between 0.01 nm and 3 mm, for example in the X-ray range, in the XUV range, in the VIS range, in the IR range, in the midIR range, or in the THz range.

9. Method according to claim 1, wherein sub-areas of the object (6) illuminated by the illumination beams (9) in adjacent positions spatially overlap.

10. Imaging system for carrying out the method according to claim 1, with
an illumination light source (2) arranged for generation of at least partially coherent electromagnetic radiation (3) which contains spectral components at at least two different wavelengths,
a separating element (4) arranged for spatial separation of the spectral components of the electromagnetic radiation (3),
a mask (7) with at least one structured aperture (8a, 8b, 8c), arranged for generation of structured illumination beams (9) by selecting respectively one of the spectral components by means of the structured aperture (8a, 8b, 8c),
a positioning element (10), arranged for moving the object (6) in a direction transverse to the path of the illumination beams (9),
an area detector (11), arranged for detecting intensity patterns which are generated by scattering or diffraction of the illumination radiation (9) at the object (6) in a detection plane defined by the plane of the area detector (11),
a control unit, arranged for controlling the positioning element (10) and the area detector (11) in such a way that the object is moved sequentially into two or more predetermined positions and several intensity patterns (9) are detected, wherein each of the positions is assigned to a detected intensity pattern (9), and
a computer which is configured by software to reconstruct an image of the object (6) from the detected intensity patterns (9) for each of the at least two wavelengths by means of a ptychographic reconstruction algorithm.

11. Imaging system according to claim 10, wherein the separating element (4) is an angularly dispersive optical element arranged in the beam path between the illumination light source (2) and the mask (7), for example a diffraction grating or a prism.

12. Imaging system according to claim 10, wherein the mask (7) arranged in the beam path between the separating element (4) and the object (6) has several structured apertures (8a, 8b, 8c) arranged next to and/or above each other.

13. Imaging system according to claim 12, wherein the apertures (8a, 8b, 8c) are structured differently so that the illumination beams (9) assigned to the different wavelengths are structured differently.

14. Imaging system according to claim 10, wherein the separating element (4) and the mask (7) can be variably aligned and/or positioned relative to each other in order to vary the spectral components selected by means of the mask (7).

15. Imaging system according to claim 10, with a focusing optic (5) arranged in the beam path between the separating element (4) and the mask (7), arranged for focusing the illumination beams (9) on the object (6).
